(19) United States
(12) Patent Application Publication
(10) Pub. No.: US 2019/0264497 A1
(43) Pub. Date: Aug. 29, 2019

(54) CONCEALED SAFETY BRACKET

(71) Applicant: Paul KOLIAS, Minneapolis, MN (US)

(72) Inventor: Paul KOLIAS, Minneapolis, MN (US)

(21) Appl. No.: 16/287,506

(22) Filed: Feb. 27, 2019

Related U.S. Application Data
(60) Provisional application No. 62/635,861, filed on Feb. 27, 2018.

(51) Int. Cl. E06B 9/01

(52) U.S. Cl. CPC E06B 9/01; E06B 2009/002

(57) ABSTRACT

A bracket includes a first portion and a second portion separable from the first portion. The first portion can be connected to a structure of a building and the second portion can be connected to a temporary barrier. After use, the second portion can be separated from the first portion.

### BACKGROUND

During construction, buildings often include openings for placement of exterior doors and windows. Prior to installation of doors and windows, these openings present safety hazards (e.g., fall hazards). Due to these safety hazards, governmental entities such as the Occupational Health and Safety Administration (OSHA) require establishing a temporary barrier during construction to prevent accidental falls. In one current approach, temporary barriers (e.g., 2″×4″ boards) are directly affixed to interior walls of the building and cover the openings. This approach can disrupt some aspects of construction on the interior and exterior of the building, which can lead to undesirable delays and/or premature removal of the barrier.

### SUMMARY

A bracket includes a first portion and a second portion separable from the first portion. The first portion can be connected to a structure of a building and the second portion can be connected to a temporary barrier. After use, the second portion can be separated from the first portion.

### BRIEF DESCRIPTION OF THE DRAWINGS

FIG. 1 is a top plan view of an exemplary bracket.

FIG. 2 is a front view of the bracket of FIG. 1.

FIG. 3 is a side view of the bracket of FIG. 1.

FIG. 4 is a schematic exterior view of a wall panel having brackets and temporary barriers installed.

FIG. 5 is a perspective view of an alternative bracket.

FIG. 6 is a cross-sectional view of a separation joint.

### DESCRIPTION

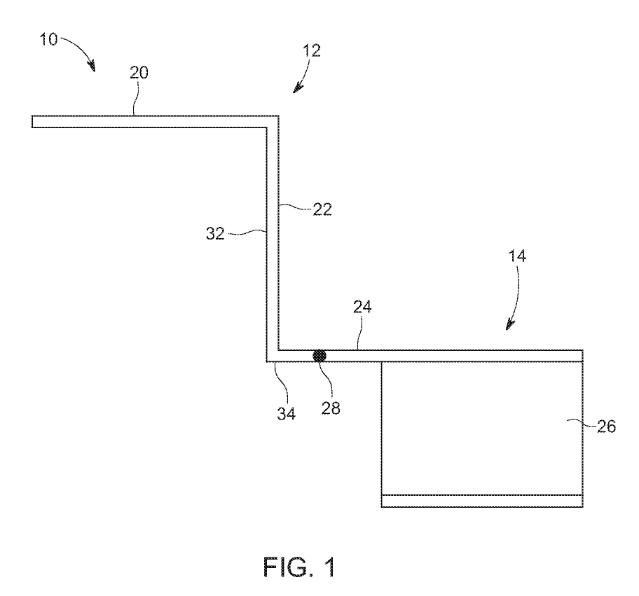

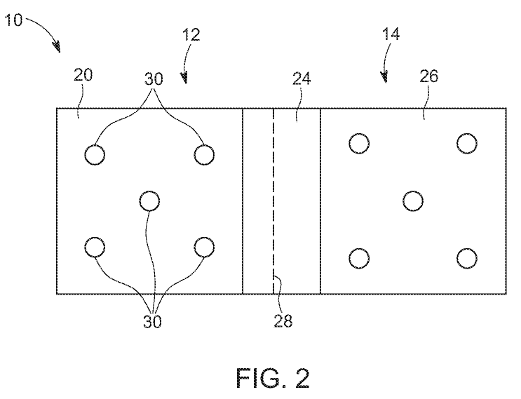

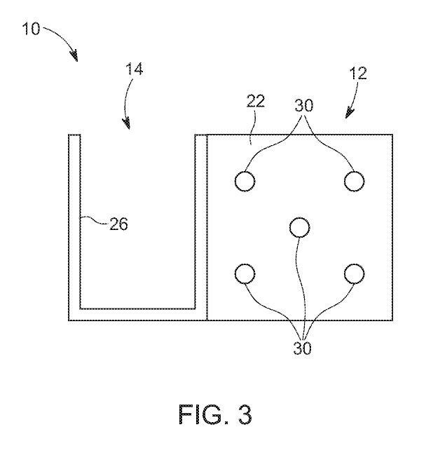

FIGS. 1-3 illustrate one embodiment of an example bracket 10. The bracket 10, as illustrated, includes a first portion 12 that can be connected to a portion of a building (e.g., a structure such as a wall) and a second portion 14 that can be connected to a temporary barrier. During construction, the first portion 12 is secured to the portion of the building and the second portion 14 is secured to the temporary barrier. Finishing pieces (e.g., siding, a door or window, drywall) can be positioned over the first portion 12 to conceal the first portion 12 such that the first portion 12 is not visible after construction is complete. The second portion 14 of the bracket 10 is separable from the first portion 12 such that the temporary barrier and second portion 14 of the bracket 10 can be removed from the first portion 12 when the temporary barrier is no longer needed. For example, after a door or window is installed in an opening and the opening does not present a safety hazard, the second portion 14 of the bracket 10 can be separated from the first portion 12.

During use, the bracket 10 and temporary barrier operate to prevent accidental falls through an opening. For example, OSHA standards require a temporary barrier to withstand 250 pounds of weight without failure in the event a person falls against the temporary barrier. After use, the temporary barrier and second portion 14 are separated from the first portion 12 such that the first portion 12 remains in place.

In the embodiment illustrated, bracket 10 is formed of a single, unitary body. In other embodiments, bracket 10 can be formed of multiple elements and connected together in various ways. Bracket 10 can be formed of various materials including plastic, fiberglass, metal and/or various materials or combinations of materials. The first portion 12 includes a first, external segment 20 and a second, intermediate segment 22. In addition, the second portion 14 includes a third segment 24 having an optional barrier support 26. A separation joint or portion 28 connects the first portion 12 to the second portion 14.

Segments 20 and 22 are generally planar and positioned orthogonal to one another. In other embodiments, segments 20 and 22 are connected at other angle such as an acute angle between the segments 20 and 22 (i.e, any angle between 0 and 90 degrees). For example, the angle can be about 10-30 degrees, about 30-50 degrees, about 50-70 degrees or other angles as desired.

During use, segments 20 and 22 can be secured to a building portion such as a wall panel or other structure using fasteners (e.g., screws, nails) extending through apertures 30 within the segments 20 and 22. In other embodiments, only one of the segments 20 and 22 can be secured to the building portion. For example, segment 20 can form a lip without apertures for fasteners, yet serve to easily engage the building portion so as to locate the second portion 14 at a selected distance from the position where segment 20 engages the building portion. Alternatively, segment 22 can be formed without apertures for fasteners, wherein segment 20 is secured to the building portion.

Segment 24 can be secured to a temporary barrier. To that end, segment 24 can include a barrier support 26, herein embodied as a trough, or other element used to support a temporary barrier. In the embodiment illustrated, barrier support 26 can be U-shaped in cross-section and sized to fit a standard 2″×4″ board that serves as a temporary barrier.

Separation joint 28 connects segment 22 to segment 24. In the embodiment illustrated, segment 22 can form a first, planar portion 32 and a second, lip portion 34 that extends from the planar portion 32 to the separation joint 28. The lip portion 34 can extend a selected distance from the planar portion 32 depending on a thickness of a door or window jamb (e.g., ½″, ⅝″, ¾″, etc.). The separation joint 28 can take several forms such as a perforated score line, pin and slot connection, v-shaped trough, buckle and others. In other embodiments, lip portion 34 can be eliminated wherein separation joint 28 is flush with a surface of planar portion 32

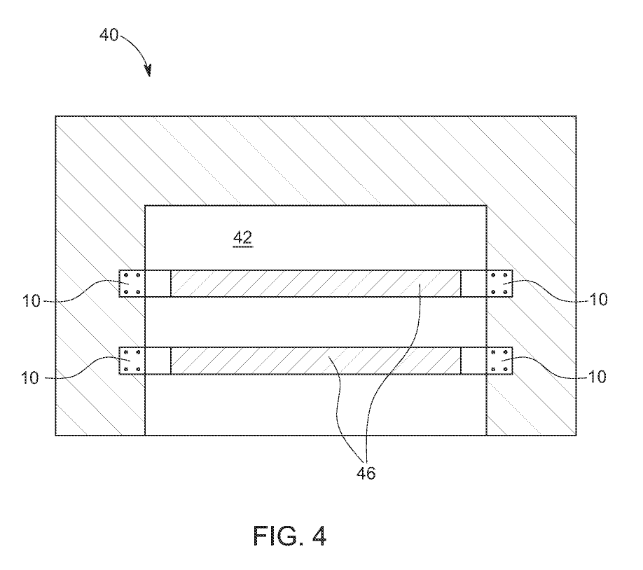

Bracket 10 is useful in providing a support for a temporary barrier within an opening. FIG. 4 is a schematic view two brackets 10 connected to an exterior side of a wall panel 40 defining an opening 42. Opening 42 generally defines an opening for installation of a door or window. The brackets 10 can be secured to the exterior of the wall panel 40 and positioned to secure one or more temporary barriers 46 thereto. In one embodiment, wall panel 40 can be fabricated remote from a construction site and positioned into place when transported to the construction site. During construction, wall panel 40 is positioned within a building. Exterior siding can be positioned over the brackets 10 so as to conceal the brackets 10 upon completion of construction.

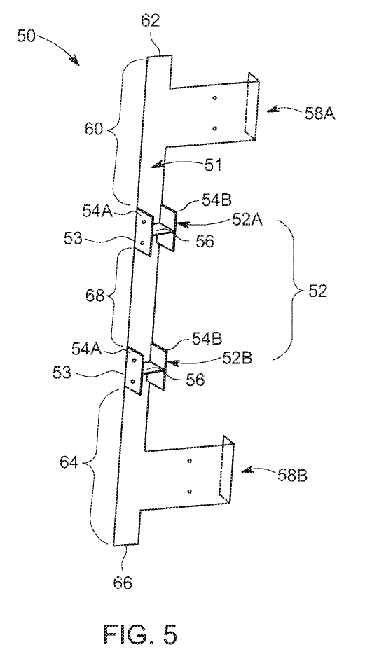

FIG. 5 illustrates an alternative bracket 50 that includes a first portion 51 and a second portion 52 formed of multiple segments 52A and 52B (i.e., an upper segment 52A and a lower segment 52B) spaced apart from one another along the first portion 51. Each of the segments 52A and 52B are spaced apart from one another at a selected distance. Each of the segments 52A, 52B is configured to be separated from the first portion 51 at a separation joint 53. In the embodiment illustrated, separation joint 53 is co-planar with a major planar surface of first portion 51. In other embodiments, separation joint 53 can be spaced apart from the major surface. The separation joint 53 can take several forms such as a perforated score line, pin and slot connection, v-shaped trough, buckle and others.

In the embodiment illustrated, each segment 52A and 52B includes sidewalls 54A and 54B and a barrier support 56 connecting the side walls 54A and 54B. Together, the sidewalls 54A, 54B and barrier support 56 form an “H” configuration. Based on this configuration, segments 52A, 52B are operable to support a barrier in a first orientation, where segment assembly 58A is located on an upper side of the bracket 50 and a second orientation, where bracket 58B is on an upper side of the bracket 50. Accordingly, bracket 50 is operable to be positioned on a left side of an opening or a right side of an opening. In other embodiments, the segments 52A and 52B are similar in construction to segment 24 described above.

The first portion 51 optionally includes multiple segment assemblies 58A and 58B that are similar in construction to segments 20 and 22 discussed above. A first vertical extension 60 spaces segment 52A from a first edge 62 of the bracket 50 and a second vertical extension 64 spaces segment 52B from a second edge 66 of the bracket 50. A third intermediate vertical extension 68 spaces segments 52A and 52B from one another. In one embodiment, a length of vertical extension 60, vertical extension 62 and vertical extension 68 are selected to position barrier supports 56 at selected heights such that the barrier supports 56 are located at heights required by OSHA standards. For example, in one embodiment, each of the barrier supports 56 are spaced from their respective edges 62 and 66 a distance of 17.5″. Additionally, the barrier supports are spaced apart from one another a distance of 21″. During installation of bracket 50, an installer can align edge 62 or edge 66 with an edge of a wall panel or similar structure so barrier supports 56 are then positioned at selected, desired heights.

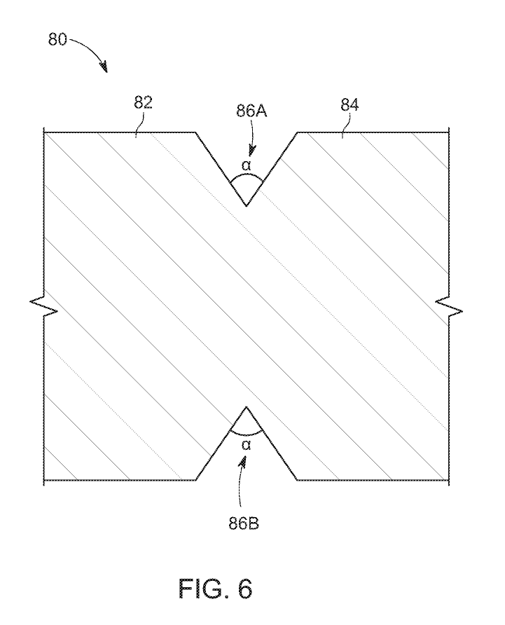

FIG. 6 is a cross-section of an example separation joint 80 that is useful as either separation joint 28 or separation joint 53 discussed above. The separation joint 80 connects a first portion 82 with a second portion 84. In the embodiment illustrated, the separation joint 80 is formed of opposed, v-shaped troughs 86A and 86B. A depth of the troughs 86A, 86B can be selected so as to provide sufficient rigidity, yet still be configured to be cut so as to separate first portion 82 from second portion 84. In one embodiment, a distance between the troughs 86A, 86B is selected as approximately 20-40% of an overall thickness of the first portion 82 and second portion 84. An angle ∝ of the troughs 86A, 86B can further be selected as desired and can for example be from 10-90°.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A bracket, comprising:
a first portion; and
a second portion connected with the first portion, wherein the first portion is configured to be secured to a structure of a building and the second portion is configured to support a temporary barrier and be separated from the first portion.

2. The bracket of claim 1, wherein the first portion includes a first segment and a second segment connected to the first segment.

3. The bracket of claim 2, wherein the first segment is configured to be connected to an exterior of the building and the second segment is configured to be connected to a door or window jamb.

4. The bracket of claim 2, wherein the first segment extends orthogonal to the second segment.

5. The bracket of claim 1, wherein the first portion defines a plurality of apertures sized to receive fasteners to fasten the first portion to the structure.

6. The bracket of claim 1, wherein the second portion defines a U-shaped barrier support sized to support the temporary barrier.

7. The bracket of claim 1, wherein the first portion is connected to the second portion at a separation joint.

8. The bracket of claim 7, wherein the separation joint is a perforated score line.

9. The bracket of claim 7, wherein the separation joint is formed of a v-shaped trough.

10. The bracket of claim 9, wherein the separation joint includes opposed v-shaped troughs.

11. The bracket of claim 1, wherein the bracket defines a lower edge, wherein the second portion includes lower and upper barrier supports, and wherein the first portion includes a first vertical extension locating the lower barrier support at a first distance from the lower edge and a second vertical extension locating the upper barrier support at a second distance from the lower edge.

12. A method of forming a temporary barrier within an opening, comprising:
securing a first portion of a bracket to a structure of a building;
positioning a temporary barrier within a second portion of the bracket; and
separating the second portion from the first portion.

13. The method of claim 12, wherein the first portion includes a first segment and a second segment connected to the first segment.

14. The method of claim 13, further comprising:
connecting the first segment to an exterior of the building; and
connecting the second segment to a door or window jamb.

15. The method of claim 12, further comprising:
securing a third portion of a second bracket to the structure, the second bracket positioned on an opposite side of the opening from the first-mentioned bracket; positioning the temporary barrier within a fourth portion of the second bracket; and
separating the third portion from the fourth portion.

16. The method of claim 12, further comprising:
covering the first portion of the bracket with siding.

17. The method of claim 12, further comprising:
positioning a second temporary barrier within the opening, the second temporary barrier positioned at a different height than the first-mentioned temporary barrier.

18. A wall panel, comprising:
a wall defining an opening;
a first bracket positioned on a first side of the opening and including a first portion attached to the wall and a second portion attached to a temporary barrier; and
a second bracket positioned on a second side of the opening and including a third portion attached to the wall and a further portion attached to the temporary barrier, wherein the temporary barrier is positioned over the opening.

19. The wall panel of claim 18, further comprising:
a second temporary barrier positioned of a different height than the first-mentioned temporary barrier, the second temporary barrier connected to the second portion of the first bracket and the fourth portion of the second bracket.

20. The wall panel of claim 19, wherein the second portion of the first bracket includes a first segment that supports the first-mentioned temporary barrier and a second segment that supports the second temporary barrier.
